(19) United States
(12) Patent Application Publication
(10) Pub. No.: US 2009/0114890 A1
(43) Pub. Date: May 7, 2009

(54) Nanocomposite Coating for Reflection Reduction

(75) Inventor: Timothy J. Imholt, Richardson, TX (US)

Correspondence Address: BAKER BOTTS LLP, 2001 ROSS AVENUE, 6TH FLOOR, DALLAS, TX, 75201-2980, US

(73) Assignee: Raytheon Company, Waltham, MA (US)

(21) Appl. No.: 12/244,970

(22) Filed: Oct. 3, 2008

Related U.S. Application Data
(60) Provisional application No. 60/977,217, filed on Oct. 3, 2007.

(51) Int. Cl. C09D 5/32; C09D 5/33; C25D 13/02; B82B 1/00; B82B 3/00

(52) U.S. Cl. 252/587; 524/495; 204/471; 977/902; 977/842; 977/750

(57) ABSTRACT

In some embodiments, a coating comprises a host material and a plurality of carbon nanotubes dispersed in the host material to form a composite coating. The weight percentage of carbon nanotubes in the composite coating may be less than 2.5 percent. More than ninety-five percent of the plurality of carbon nanotubes may be single wall carbon nanotubes.

### RELATED APPLICATION

This patent application claims priority from Provisional Patent Application Ser. No. 60/977,217, filed Oct. 3, 2007, entitled Nanocomposite Coating for Reflection Reduction.

### TECHNICAL FIELD

The present disclosure relates generally to composite coatings and more particularly to a nanocomposite coating for reflection reduction.

### BACKGROUND

Traditional coatings for military vehicles and other hardware include conventional paint and/or metallic finishes. Such coatings generally reflect infrared and ultraviolet radiation. As a result, such coatings do not protect military vehicles and hardware from being tracked by laser guided weapons.

### SUMMARY

In some embodiments, a coating comprises a host material and a plurality of carbon nanotubes dispersed in the host material to form a composite coating. The weight percentage of carbon nanotubes in the composite coating may be less than 2.5 percent. More than ninety-five percent of the plurality of carbon nanotubes may be single wall carbon nanotubes.

According to certain embodiments, a method comprises depositing a plurality of carbon nanotubes in a host material to form a composite coating. At least ninety-five percent of the plurality of carbon nanotubes may be single wall nanotubes having respective diameters equal to or less than 1.5 nanometers. The method may further comprise dispersing the plurality of carbon nanotubes in the host material, the dispersion caused by an electric field.

In some embodiments, a method comprises mixing carbon monoxide with an iron material in a high-pressure carbon monoxide reactor. The method may further comprise heating the mixture to at least 1000° C. such that at least a portion of the iron material catalyzes a Boudouard reaction that produces a plurality of carbon nanotubes. The method may further comprise depositing the plurality of carbon nanotubes in paint to form a composite coating. At least ninety-nine percent of the plurality of carbon nanotubes may be single wall nanotubes having respective diameters equal to or less than 1.5 nanometers. The weight percentage of carbon nanotubes in the composite coating may be from one to two percent. The method may further comprise dispersing the plurality of carbon nanotubes in the host material, the dispersion caused by an electric field.

Certain embodiments of the composite coating may offer various advantages. Some, none, or all embodiments may benefit from the below described advantages. One advantage is that the composite coating may absorb infrared radiation that is incident to an object coated with the composite coating. The composite coating may thereby reduce or eliminate the reflection of infrared radiation off of the coated object. By reducing the reflection of infrared radiation, the composite coating may prevent a laser guided munitions system from detecting and/or targeting the coated object.

Another advantage is that the nanotubes in the composite coating may be single wall nanotubes. The amount of single wall nanotube in the composite coating may be configured so that the reflectivity of the composite coating is reduced without reducing the strength and/or durability of the composite coating. Yet another advantage is that the nanotubes may be evenly dispersed in the composite coating. The even dispersion of the nanotubes may be achieved at least in part by an electrophoretic process. Further advantages are described in greater detail below.

Other advantages will be readily apparent to one skilled in the art from the description and the appended claims.

### BRIEF DESCRIPTION OF THE DRAWINGS

FIG. 1 illustrates a nanocomposite coating that may reduce the reflection of electromagnetic radiation from an object, according to certain embodiments;

FIG. 2 illustrates carbon nanotubes, according to certain embodiments;

FIG. 3 illustrates a graph of the radiation extinction properties of single wall nanotubes, according to certain embodiments;

FIG. 4 illustrates a graph of the absorption spectra of single wall nanotubes, according to certain embodiments;

FIG. 5 illustrates a graph of the reflective spectra of a coating comprising single wall nanotubes, according to certain embodiments;

FIG. 6 illustrates a HiPCO reactor for making single wall nanotubes, according to certain embodiments;

FIG. 7 illustrates an electrophoretic system for dispersing nanotubes in a host material, according to certain embodiments; and

FIG. 8 illustrates a method for forming a composite coating, according to certain embodiments.

### DETAILED DESCRIPTION OF EXAMPLE EMBODIMENTS

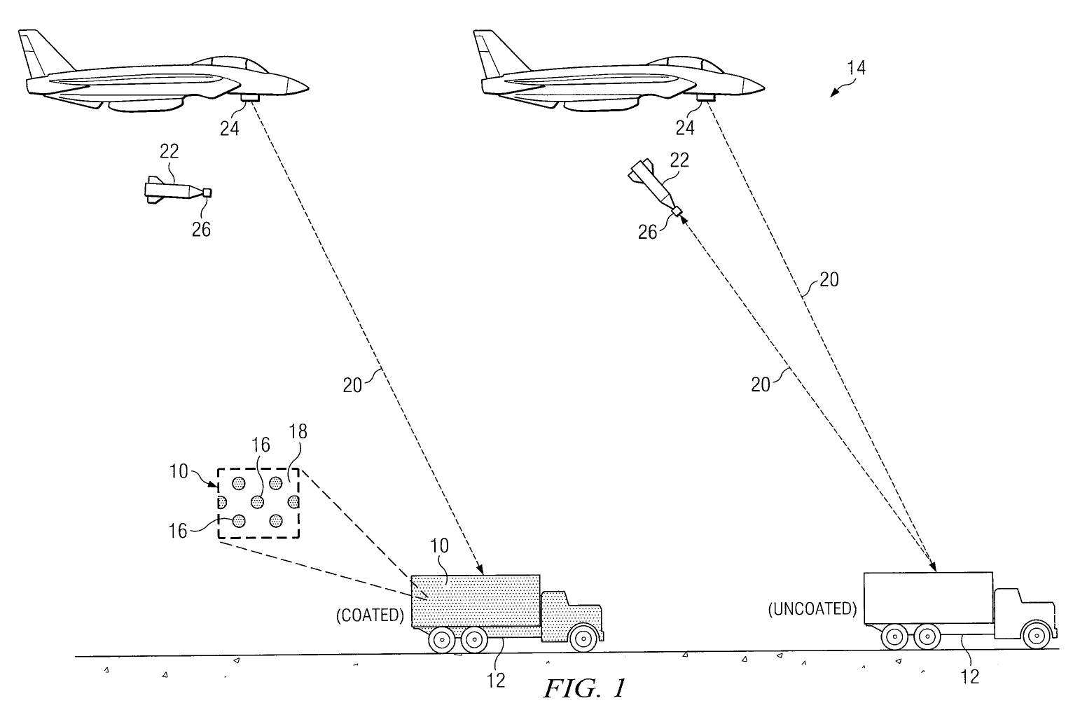

FIG. 1 illustrates a nanocomposite coating 10 that may reduce the reflection of electromagnetic (EM) radiation from an object 12, according to certain embodiments. In some embodiments, coating 10 may cloak object 12 from a guided munitions system 14. Coating 10 may comprise a plurality of nanotubes 16 dispersed in a host material 18.

Nanotube 16 refers to a type of nanostructure. A nanostructure has a physical size that, in at least one dimension, is in the range of 0.8 to 100 nanometers. As long as at least one dimension of a given structure falls within this nanoscale range, the structure may be considered a nanostructure. In some embodiments, a nanostructure may exhibit one or more properties that a larger structure (even a larger structure made from the same atomic species) does not exhibit. Nanostructures may have various shapes and may comprise various materials.

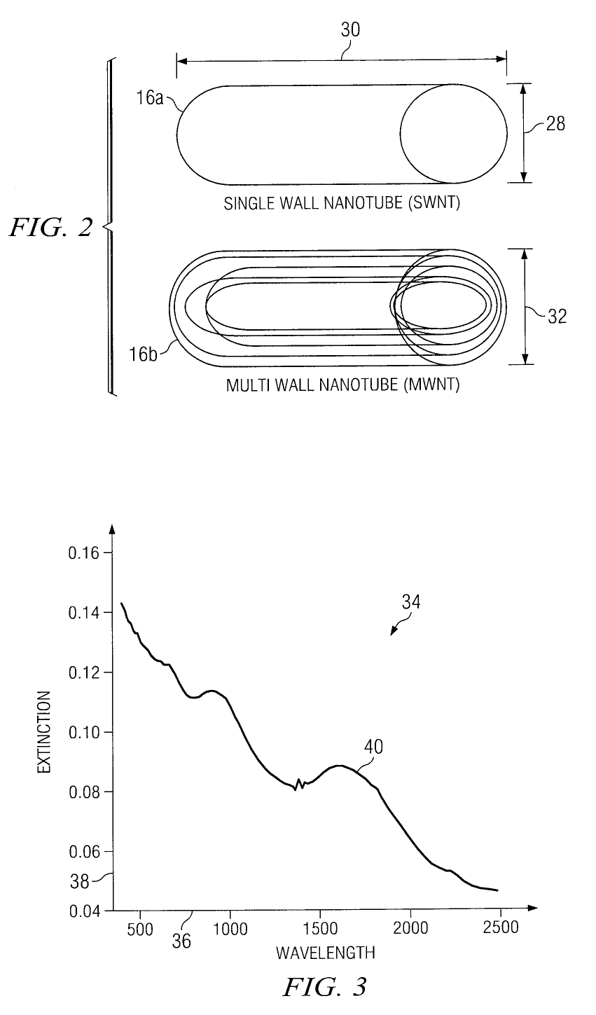

Nanotube 16 is a type of nanostructure that appears as a cylinder or as concentric cylinders. In some embodiments, nanotubes 16 are made of carbon. In other embodiments, nanotubes 16 are synthesized from inorganic materials such as, for example, boron nitride, silicon, titanium dioxide, tungsten disulphide, and molybdenum disulphide. Coating 10 may comprise any suitable type and/or combination of nanotubes 16. Nanotubes 16 may be manufactured by various techniques such as, for example, arc discharge, laser ablation, high pressure carbon monoxide (HiPCO), and chemical vapor deposition (CVD). The properties and structure of nanotubes 16 are described in further detail with respect to FIG. 2.

Nanotubes 16 may be mixed into host material 18 to form coating 10. Host material 18 comprises any suitable matrix, substrate, and/or other material that may be coated on or applied to the surfaces of object 12. In some embodiments, host material 18 is a paint, resin, polymer, ceramic, thermoplastic, and/or any other suitable binder material. According to certain embodiments, host material 18 comprises one or more synthetic or natural resins such as, for example, acrylics, polyurethanes, polyesters, melamine resins, epoxy, and/or oils. In some embodiments, host material 18 comprises a lacquer (e.g., nitrocellulose lacquer) and/or an enamel (e.g., alkyd enamel or acrylic enamel). Prior to curing or drying, host material 18 may be in a liquid state at room temperature. After curing or drying, host material 18 may be in a solid state.

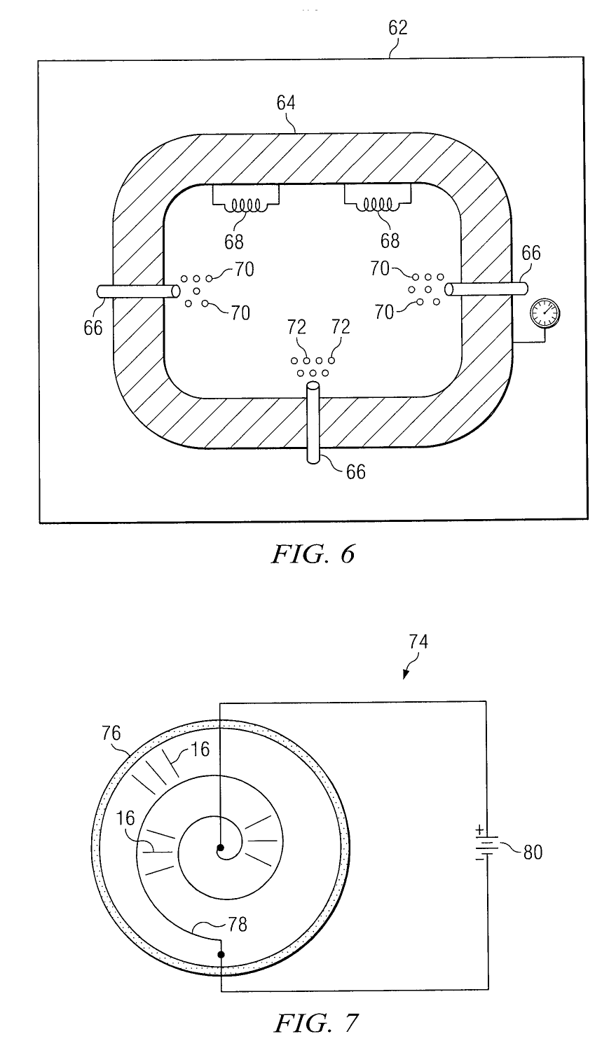

Coating 10 may be a composite of nanotubes 16 and host material 18. Thus, within coating 10, the individual nanotubes 16 may remain separate and distinct from the particles of host material 18. Nanotubes 16 may impart to coating 10 their properties of energy absorption. Coating 10 may be configured to have any suitable proportion of nanotubes 16 to host material 18. In some embodiments, coating 10 may be configured such that it comprises a sufficient amount of nanotubes 16 to increase the absorption of EM radiation without reducing the strength, durability, and/or elasticity of host material 18 in coating 10. In some embodiments, coating 10 may be configured such that the weight percentage of nanotubes 16 in coating 10 is from 1.0 to 2.5 percent (e.g., nanotubes 16 account for 1.0 to 2.5 percent of the total weight of coating 10). In other embodiments, coating 10 may be configured such that the weight percentage of nanotubes 16 in coating 10 is from 1.5 to 2.0 percent. The manufacture and composition of coating 10 is described in further detail with respect to FIGS. 6-7 below.

As explained above, coating 10 may cloak object 12 from guided munitions system 14. Guided munitions system 14 generally uses light beams 20 to guide a projectile 22 towards a targeted object 12. Guided munitions system 14 may comprise laser designators 24 and projectiles 22. Laser designator 24 may generate and direct light beam 20 to illuminate object 12. Light beam 20 may be any suitable type of EM radiation such as, for example, infrared light. If the illuminated object 12 is an uncoated object 12, a portion of light beam 20 may be reflected. The portion of light beam 20 that is reflected from uncoated object 12 may be detected by a seeker head 26 on projectile 22. Seeker head 26 may transmit signals to the control mechanisms (e.g., fins) of projectile 22 to guide projectile 22 towards the uncoated object 12. Thus, projectile 22 relies on the reflected portion of light beam 20 to track object 12.

In some embodiments, coating 10 may be applied to objects 12 to protect them from being sensed or tracked by projectile 22. As noted above, nanotubes 16 in coating 10 may impart their energy absorption properties to coating 10. As a result, coating 10 may absorb, rather than reflect, all or a portion of light beam 20 from laser designator 24. Because coating 10 may reduce or eliminate the reflection of light beam 20, projectile 22 may be unable to locate and/or track coated objects 12. Accordingly, objects 12 having coating 10 may be protected from guided munitions system 14. Coating 10 may be applied to any suitable objects 12 such as, for example, vehicles, boats, aircraft, buildings, oil drums, and/or any suitable object 12.

FIG. 2 illustrates carbon nanotubes 16, according to certain embodiments. Carbon nanotubes 16 may generally be single walled or multi-walled. A single wall nanotube (SWNT) 16a may comprise a one-atom thick sheet of graphite (referred to as graphene) that is rolled into a cylinder. In some embodiments, SWNT 16a may have a diameter 28 that is from 0.8 to 2.0 nm. In other embodiments, diameter 28 of SWNT 16a may be from 1.0 to 1.5 nm. The tube length 30 of SWNT 16a may be many times longer (e.g., thousands of times longer) than diameter 28 of the SWNT 16a. Accordingly, SWNT 16a may have a large aspect ratio (e.g., the length to diameter ratio may exceed 10,000). The ends of SWNT 16a (i.e., the ends of the cylindrical structure) may appear to be capped with hemispherical structures. Thus, SWNT 16a may appear as a capped pipe. SWNT 16a may have a “zigzag,” “armchair,” or “chiral” structure.

A multi-wall nanotube (MWNT) 16b is a multiple layered structure of nanotubes 16 nested within one another. The number of layers in MWNT 16b may range from two to more than ten. According to one model (i.e., the Russian Doll model), MWNT 16b comprises sheets of graphite that are arranged in concentric cylinders. According to another model (i.e., the Parchment model), MWNT 16b comprises a single sheet of graphite that is rolled in around itself, resembling a scroll of parchment or a rolled up newspaper. The interlayer distance in MWNT 16b may be similar to the distance between graphene layers in graphite (e.g., approximately 3.3 angstroms). In some embodiments, MWNT 16b exhibits electrical conductivity that is similar to that of graphene. In some embodiments, MWNT 16b may have a diameter 32 that is from ten to one hundred nm. In other embodiments, diameter 32 of MWNT 16b may be from twenty to one hundred nm. Some MWNTs 16b may be double wall carbon nanotubes (DWNTs) and others may be triple wall carbon nanotubes (TWNTs).

Nanotubes 16 (e.g., MWNTs 16b and SWNTs 16a) may exhibit unique properties. For example, nanotubes 16 tend to be strong and stiff (e.g., carbon nanotubes 16 may have a tensile strength of over 50 GPa). The strength of nanotubes 16 may be attributed, at least in part, to their chemical composition. In terms of orbital hybridization, the chemical bonds between carbon atoms in SWNTs 16a and MWNTs 16b may be sp² bonds, which are generally harder to break than sp³ bonds found in diamonds. In addition to their strength, nanotubes 16 may be generally conductive or semiconductive to electricity. This electrical property may cause nanotubes 16 to clump together, in some embodiments.

As explained above, nanotubes 16 may cause coating 10 to absorb EM radiation and to reduce the reflective properties of a coated object 12. The wave-particle duality of EM radiation (coupled with the physical size of nanotubes 16) may offer multiple pathways for interaction between EM radiation and nanotubes 16. EM waves generally display properties of specular and diffuse reflection. Specular reflection refers to mirror-like reflection of light where the angle of incidence of an incoming beam generally equals the angle of reflection. Diffuse reflection refers to the reflection of light from a granular surface such that any incident beam is reflected at a number of angles. Laser guided munitions systems 14 may use specular reflection and/or diffuse reflection to lock onto a target. Nanotubes 16 may reduce or eliminate specular reflection and/or diffuse reflection.

Nanotubes 16 may reduce and/or eliminate reflection by absorbing EM radiation. Due to the laws of conservation of energy, the energy of an absorbed photon becomes some other form of energy. In particular, the energy of an absorbed photon may (1) become thermal energy, (2) be transformed to mechanical motion, and/or (3) result in a photon being re-emitted at a different wavelength. Nanotubes 16 may provide any or all of these mechanisms for absorption.

In some embodiments, SWNTs 16a exhibit properties that are not shared by MWNTs 16b. SWNTs 16a may behave as positive field effect transistors (p-FETs) when exposed to oxygen and as negative field effect transistors (n-FETs) when unexposed to oxygen. In some embodiments, SWNTs 16a are more absorptive of EM radiation (such as, for example, infrared light) than MWNTs 16b. The enhanced EM absorption of SWNTs 16a may be due, at least in part, to the smaller diameter 28 of SWNTs 16a. Although various nanotube properties are described above with respect to carbon SWNTs 16a and MWNTs 16b, it should be understood that coating 10 may comprise non-carbon nanotubes 16 that exhibit similar and/or analogous properties.

FIG. 3 illustrates a graph 34 of the radiation extinction properties of SWNTs 16a, according to certain embodiments. Graph 34 comprises an x-axis 36 representing wavelengths of EM radiation that is incident on a sample of SWNTs 16a. Graph 34 further comprises a y-axis 38 representing the extinction (i.e., absorption and scattering) of EM radiation by the sample of SWNTs 16a. Graph 34 further comprises a line 40 that illustrates the extinction of various wavelengths of EM radiation caused by the sample of SWNTs 16a. As illustrated in graph 34, SWNTs 16a may exhibit greater extinction of infrared radiation in the wavelength range of 800 to 1570 nm than in the range of longer wavelengths (e.g., longer than 2000 nm).

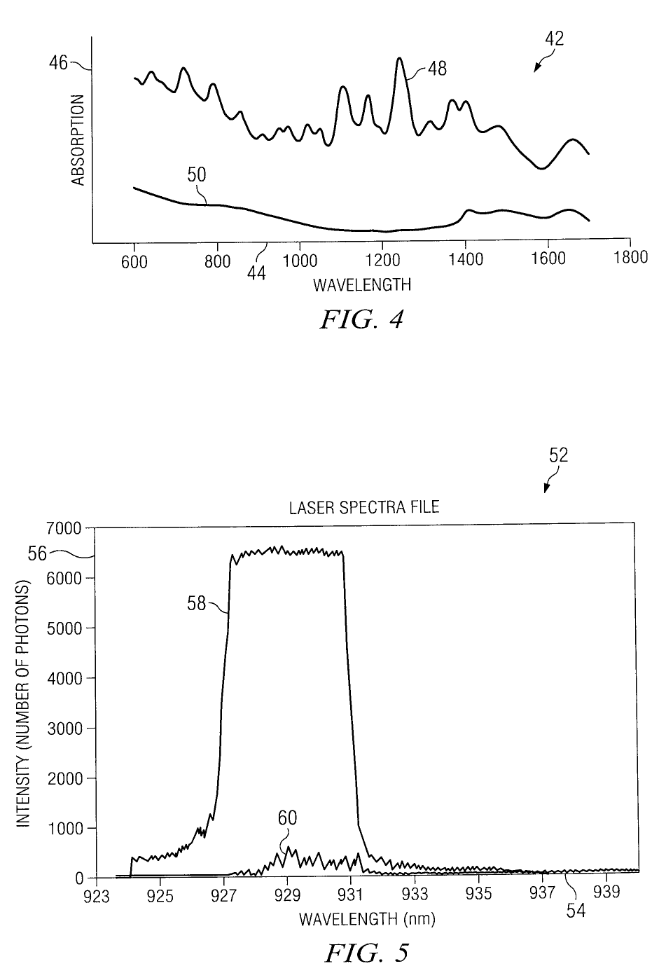

FIG. 4 illustrates a graph 42 of the absorption spectra of SWNTs 16a, according to certain embodiments. Graph 42 comprises an x-axis 44 representing wavelengths of infrared radiation and a y-axis 46 representing the absorbance of infrared radiation. Graph 42 further comprises a first line 48 that illustrates the absorbance of various wavelengths of infrared radiation by SWNTs 16a. Graph 42 further comprises a second line 50 that illustrates the absorbance of various wavelengths of infrared radiation by MWNTs 16b. As illustrated by graph 42, SWNTs 16a may be more absorptive of infrared radiation than MWNTs 16b. In some embodiments, a particular amount of SWNTs 16a may absorb at least twice as much infrared radiation as the same amount of MWNTs 16b. In other embodiments, a particular amount of SWNTs 16a may absorb at least four times as much infrared radiation as the same amount of MWNTs 16b. Thus, objects 12 that have coating 10 may exhibit a reduced infrared reflection signature, which may prevent projectiles 22 from tracking such objects 12. Thus, coating 10 may reduce the likelihood of a coated object 12 being destroyed by laser guided munitions.

FIG. 5 illustrates a graph 52 of the reflective spectra of coating 10 comprising SWNTs 16a, according to certain embodiments. Graph 52 comprises an x-axis 54 representing wavelengths of infrared radiation and a y-axis 56 representing intensity of infrared radiation (expressed as numbers of photons). Graph 52 comprises a first line 58 representing the intensity of infrared radiation directed from a radiation source (e.g., laser) to a surface that is coated with coating 10. Graph 52 also comprises a second line 60 representing the intensity of infrared radiation reflected from the coated surface. In the illustrated example, host material 18 in coating 10 is paint and at least ninety-five percent of nanotubes 16 in coating 10 are carbon SWNTs 16a. In this example, each carbon SWNT 16a has diameter 28 equal to or less than 1.5 nm and the weight percentage of SWNTs 16a in coating 10 is within the range of 1.5 to 2.0 percent (e.g., SWNTs 16a represent 1.5 to 2.0 percent of the total weight of a given amount of coating 10). As illustrated by graph 52, the intensity of the infrared radiation that is reflected from the coated surface may be at least ten times less than the intensity of the infrared radiation that is incident on the coated surface.

Coating 10 may be manufactured according to any suitable number and combination of techniques. In some embodiments, the manufacture of coating 10 may comprise using a High-Pressure Carbon Monoxide (HiPCO) process to make SWNTs 16a and an electrophoretic process to mix SWNTs 16a with host material 18. FIG. 6 illustrates a HiPCO reactor 62 for making SWNTs 16a, according to certain embodiments. Reactor 62 may comprise a chamber 64 having ports 66 and heating elements 68. Chamber 64 may be formed of any material suitable for housing a high-pressure reaction. In some embodiments, chamber 64 may be a cylindrical aluminum chamber 64 having walls of a configurable thickness (e.g., thicker than one inch, two inches, and/or any suitable thickness). The walls of chamber 64 may comprise one or more ports 66.

Port 66 may be an inlet, injector, and/or other suitable orifice that permits materials to be injected into chamber 64. In some embodiments, chamber 64 may comprise one port 66 for injecting a reactant 70 into chamber 64 and another port 66 for injecting a catalyst 72 into chamber 64. Port 66 may be of any suitable size and/or shape. In some embodiments, port 66 may be associated with one or more valves that control the quantity and/or flow rate of reactant 70 and/or catalyst 72 injected into chamber 64. Reactant 70 may be any suitable material such as, for example, a carbon material, boron material, and/or silicon material. In some embodiments, reactant 70 is a carbon gas such as, for example, carbon monoxide. Catalyst 72 may be any suitable material that triggers the formation of nanotubes 16. In some embodiments, catalyst 72 may be an iron material such as, for example, iron pentacarbonyl (Fe(CO)₅).

Chamber 64 may comprise one or more heating elements 68. Heating element 68 may be electric, gas-fired, and/or any suitable type of heating element 68. When activated, heating elements 68 may heat chamber 64 to at least 1000° C. When heated and mixed in chamber 64, catalyst 72 may trigger a reaction of reactant 70 in order to form SWNTs 16a.

An example may illustrate the operation of reactor 62. In this example, reactant 70 is carbon monoxide and catalyst 72 is iron pentacarbonyl. Reactor 62 may inject the carbon monoxide through port 66 into chamber 64. Chamber 64 may then pressurize the carbon monoxide to at least thirty bar. Reactor 62 may then introduce iron pentacarbonyl through one or more ports 66. Heating elements 68 may heat chamber 64, which may cause the iron pentacarbonyl to decompose and release free iron atoms. The free iron atoms may then nucleate and form clusters that catalyze the formation of SWNTs 16a by a disproportion reaction of carbon monoxide on the iron clusters. The reaction may be a Boudouard reaction, which may be expressed in stoichiometrically balanced form as:

FeₙCO+CO→(1−β)FeₙCO+(1+β)/2CO2+βCNTₙ

where β=1/(2N_{c}−1) and N_{c}=number of carbon atoms in a given SWNT 16a. Following the reaction, the carbon SWNTs 16a may be removed from chamber 64 and purified and/or cleaned according to any suitable technique(s).

Nanotubes 16 may be mixed with host material 18 according to any suitable technique. In some embodiments, the strong forces between atoms in nanotubes 16 may cause nanotubes 16 to clump together. Due to this clumping tendency, some prior techniques for mixing materials may be unsatisfactory for mixing nanotubes 16 with host material 18. To overcome the tendency of nanotubes 16 to clump together, an electrophoretic process may be used to mix nanotubes 16 with host material 18. As explained above, nanotubes 16 may be generally conductive or semiconductive to electricity. This conductivity may be used to cause the dispersion of nanotubes 16 in host material 18 in a generally even manner while in the presence of an electric field. The process of applying an electric field to cause the dispersion and/or alignment of nanotubes 16 in host material 18 may be referred to as electrophoresis.

FIG. 7 illustrates an electrophoretic system 74 for dispersing nanotubes 16 in host material 18, according to certain embodiments. System 74 may comprise a vessel 76 configured with an electrode 78 that is coupled to an electrical source 80. Vessel 76 may be any container that is suitable for holding liquid materials. In some embodiments, vessel 76 may be formed of glass, metal, plastic, and/or other suitable materials. Electrode 78 may be positioned in the cavity of vessel 76. Electrode 78 may be any suitable electric conductor such as, for example, copper or aluminum. Electrode 78 may be coupled to any suitable electrical source 80 such as, for example, a battery.

In operation, a configurable amount of host material 18 may be placed in vessel 76. Nanotubes 16 may then be placed in host material 18 in vessel 76. In conjunction with placing nanotubes 16 in host material 18, system 74 may activate electrical source 80, causing a current to flow through electrode 78. The electric field formed by the current in electrode 78 may cause nanotubes 16 in host material 18 to disperse in a generally even manner. Thus, the electrophoretic system 74 may permit nanotubes 16 to be mixed with host material 18 without clumping. Mixing nanotubes 16 with host material 18 may form coating 10. Coating 10 may then be packaged (e.g., in cans) according to any suitable technique(s).

In some embodiments, prior to mixing nanotubes 16 with host material 18, nanotubes 16 may be submerged in water. While nanotubes 16 are in the water, the water may be evaporated. This process may cause nanotubes 16 to absorb oxygen and hydrogen atoms from the evaporated water. This addition of oxygen and hydrogen to nanotubes 16 may further reduce the likelihood of clumping when nanotubes 16 are mixed with host material 18 to form coating 10.

As explained above, coating 10 may provide advantages for defending against guided munitions. In other embodiments, the energy absorption properties of coating 10 may provide advantages for other applications. For example, coating 10 may be applied to goggles, glasses, windshields, sunglasses, and/or other objects 12 to protect the human eye from ultraviolet radiation.

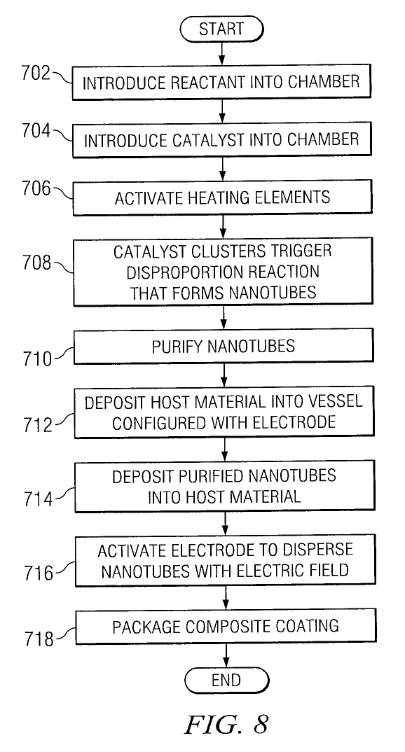

FIG. 8 illustrates a method for forming coating 10, according to certain embodiments. The method begins at step 702 when reactant 70 is introduced into chamber 64 of a HiPCO reactor 62. Reactor 62 may maintain reactant 70 in chamber 64 at a high pressure (e.g., at least twenty-five bar). Reactant 70 may be any suitable material such as, for example, a carbon, boron, and/or silicon material. In some embodiments, reactant 70 may be carbon monoxide. At step 704, reactor 62 may introduce catalyst 72 into chamber 64. Catalyst 72 may be any suitable material. In some embodiments, catalyst 72 may be an iron material such as, for example, iron pentacarbonyl. Once in chamber 64, catalyst 72 may begin to decompose, causing the release of free molecules (e.g., iron). The free molecules may nucleate and form catalyst clusters. At step 706, reactor 62 may activate heating elements 68 to heat chamber 64. Heating elements 68 may heat chamber 64 to any suitable temperature. In some embodiments, heating elements 68 heat chamber 64 to at least 1000° C. At step 708, the catalyst clusters may trigger the formation of nanotubes 16 by a disproportion reaction of reactant 70 on the catalyst clusters. In some embodiments, at least ninety-five percent of the nanotubes 16 formed by the reaction are SWNTs 16a. In other embodiments, at least ninety-nine percent of the nanotubes 16 formed by the reaction are SWNTs 16a. These SWNTs 16a may have diameters from 0.8 to 1.5 nm.

At step 710, nanotubes 16 from chamber 64 may be purified according to any suitable technique(s). At step 712, host material 18 may be poured into vessel 76 in electrophoretic system 74. Host material 18 may be a paint, resin, polymer, ceramic, thermoplastic, and/or any other suitable type and/or combination of binder materials. Electrode 78 may be positioned in host material 18 in vessel 76. At step 714, the purified nanotubes 16 may be poured into host material 18. At step 716, electric source may be activated, causing a current to flow through electrode 78 in vessel 76. The electric field created by the current through electrode 78 may cause nanotubes 16 in host material 18 to disperse in a generally even manner. Mixing nanotubes 16 with host material 18 may form coating 10. At step 718, coating 10 may be packaged according to any suitable technique(s). The method then ends.

Although the present invention has been described in several embodiments, a myriad of changes and modifications may be suggested to one skilled in the art, and it is intended that the present invention encompass such changes and modifications as fall within the scope of the present appended claims.

What is claimed is:

1. A coating, comprising:
a host material; and
a plurality of carbon nanotubes dispersed in the host material to form a composite coating, wherein:
a weight percentage of carbon nanotubes in the composite coating is less than 2.5 percent; and
more than ninety-five percent of the plurality of carbon nanotubes are single wall carbon nanotubes.

2. The coating of claim 1, wherein the host material comprises at least one of:
an acrylic material;
a polyurethane material;
a polyester material;
a melamine resin;
an epoxy; and
an oil.

3. The coating of claim 1, wherein each single wall carbon nanotube has a diameter that is equal to or less than 1.5 nanometers.

4. The coating of claim 1, wherein the plurality of carbon nanotubes are formed in a high-pressure carbon monoxide reactor.

5. The coating of claim 1, wherein:
the host material is in a liquid state prior to curing; and
the carbon nanotubes are dispersed in the host material by electrophoresis.

6. The coating of claim 1, wherein the carbon nanotubes cause the composite coating to have a lower infrared absorbance than the host material without weakening the composite coating.

7. The coating of claim 1, wherein the composite coating absorbs incident infrared light having a particular intensity such that an intensity of reflected infrared light is less than one-tenth of the particular intensity of the incident infrared light.

8. The coating of claim 1, wherein coating an object with the composite coating reduces an infrared signature of the object by at least ten times.

9. The coating of claim 1, wherein:
the weight percentage of carbon nanotubes in the composite coating is from one to two percent; and
more than ninety-nine percent of the plurality of carbon nanotubes are single wall carbon nanotubes.

10. A method, comprising:
depositing a plurality of carbon nanotubes in a host material to form a composite coating, wherein at least ninety-five percent of the plurality of carbon nanotubes are single wall nanotubes having respective diameters equal to or less than 1.5 nanometers; and
dispersing the plurality of carbon nanotubes in the host material, the dispersion caused by an electric field.

11. The method of claim 10, wherein the electric field is applied to the carbon nanotubes by at least one electrode that is positioned in the host material.

12. The method of claim 10, wherein a weight percentage of carbon nanotubes in the composite coating is less than 2.5 percent.

13. The method of claim 10, wherein the host material comprises paint.

14. The method of claim 10, further comprising forming the plurality of carbon nanotubes in a high-pressure carbon monoxide reactor.

15. The method of claim 14, wherein forming the plurality of carbon nanotubes comprises:
mixing carbon monoxide with an iron material in the high-pressure carbon monoxide reactor;
heating the mixture to at least 1000° C. such that at least a portion of the iron material catalyzes a Boudouard reaction that produces single wall carbon nanotubes.

16. The method of claim 15, wherein the iron material is iron pentacarbonyl.

17. The method of claim 10, wherein the composite coating absorbs incident infrared light having a particular intensity such that an intensity of reflected infrared light is less than one-tenth of the particular intensity of the incident infrared light.

18. The method of claim 10, wherein coating an object with the composite coating reduces an infrared signature of the object by at least ten times.

19. The method of claim 10, wherein:
a weight percentage of carbon nanotubes in the composite coating is from one to two percent; and
more than ninety-nine percent of the plurality of carbon nanotubes are single wall carbon nanotubes.

20. A method, comprising:
mixing carbon monoxide with an iron material in a high-pressure carbon monoxide reactor;
heating the mixture to at least 1000° C. such that at least a portion of the iron material catalyzes a Boudouard reaction that produces a plurality of carbon nanotubes;
depositing the plurality of carbon nanotubes in paint to form a composite coating, wherein:
at least ninety-nine percent of the plurality of carbon nanotubes are single wall nanotubes having respective diameters equal to or less than 1.5 nanometers; and
a weight percentage of carbon nanotubes in the composite coating is from one to two percent;
and
dispersing the plurality of carbon nanotubes in the host material, the dispersion caused by an electric field.
